(19) United States
(12) Patent Application Publication
(10) Pub. No.: US 2025/0267100 A1
(43) Pub. Date: Aug. 21, 2025

(54) MINIMIZED LATENCY INGRESS ARBITRATION

(71) Applicant: Marvell Asia Pte Ltd, Singapore (SG)

(72) Inventors: Vijay CHOUGULE, Tracy, CA (US); William Brad MATTHEWS, Los Gatos, CA (US); Ashwin ALAPATI, San Jose, CA (US)

(21) Appl. No.: 19/058,380

(22) Filed: Feb. 20, 2025

Related U.S. Application Data
(60) Provisional application No. 63/556,363, filed on Feb. 21, 2024.

(51) Int. Cl. H04L 47/129; H04L 49/90

(52) U.S. Cl. CPC H04L 47/129; H04L 49/90

(57) ABSTRACT

Techniques as described herein may be implemented to processing ingress packet traffic flows. A memory space that is divided into a packet buffer and an accelerated memory is defined. One or more congestion levels associated with ingress network traffic are determined. Upon enqueuing incoming packets, one or more memory locations are selected in the memory space for storing portions of each of the incoming packets based on at least one of the determined congestion levels.

### CROSS-REFERENCE TO RELATED APPLICATIONS

This application claims the benefit of priority to U.S. Provisional Patent Application No. 63/556,363 filed on Feb. 21, 2024, which is hereby incorporated by reference.

### TECHNICAL FIELD

Embodiments relate generally to computer network communications, and, more specifically, to minimized or super low latency ingress arbitration.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Ingress arbitration may be implemented in a network switch to manage and control ingress traffic flows to ensure that these traffic flows can be handled efficiently with minimized congestion, data loss, or performance degradation. At a relatively high performance network switch, terabytes of packet data per second may be received from ingress ports, processed using various packet processing resources, and forwarded out of egress ports. To handle this potential large size of incoming packet data as well as relatively large size variability and sizes among incoming packets, packet memory buffers of relatively large sizes and packet data linking structures may be used or implemented in the network switch to support buffering and accessing packet data of ingress traffic flows.

Looking up specific data fields such as packet header data fields of a given packet in relatively large packet memory buffers—for example, for packet control purposes including but not limited to determining a specific forwarding path and/or a specific egress port for forwarding the packet—may incur very large delays or time latencies, even when actual bandwidth usages of the ingress traffic flow may be relatively low compared to configured or supported bandwidth capacities in the network switch or when buffer usages of the ingress traffic flow may be relatively low compared with storage capacities of the packet memory buffers.

### BRIEF DESCRIPTION OF DRAWINGS

The present inventive subject matter is illustrated by way of example, and not by way of limitation, in the figures of the accompanying drawings and in which like reference numerals refer to similar elements and in which:

FIG. 1 illustrates an example framework for processing ingress packets;

FIG. 2A illustrates example aspects of an example networking system; FIG. 2B illustrates example aspects of a network device;

FIG. 3A illustrates example packet processing operations; FIG. 3B illustrates example ingress arbitration operations; and

FIG. 4A and FIG. 4B illustrates example process flows.

### DETAILED DESCRIPTION OF THE INVENTION

In the following description, for the purposes of explanation, numerous specific details are set forth in order to provide a thorough understanding of the present inventive subject matter. It will be apparent, however, that the present inventive subject matter may be practiced without these specific details. In other instances, well-known structures and devices are shown in block diagram form in order to avoid unnecessarily obscuring the present inventive subject matter.

### 1.0. General Overview

Techniques as described herein can be implemented or used with a network device or node such as a network (e.g., Ethernet, etc.) switch or (e.g., IP, etc.) router in a computer communication network to provide efficient ingress arbitration with a relatively low time latency. These techniques can ensure minimized or super low—for example, the lowest possible—time latencies in packet processing operations performed by an ingress arbiter operating in a no-congestion state.

A wide variety of applications and systems including but not limited to artificial intelligence (AI) and/or machine learning (ML) related applications and systems may be supported by or benefited from the techniques as described herein, which significantly reduce latency associated with processing ingress packet traffic flows as well as overall packet processing operations in the network device or node. In some operational scenarios, time latencies incurred by other approaches in ingress arbitration operations can be cut by more than 50% using the techniques as described herein.

In many operational scenarios, an ingress arbiter may be configured to perform buffering of lossless inflight data and manage packet rate oversubscription and/or congestion events or conditions. An oversubscription or congestion event or condition occurs when an (aggregated) incoming packet rate exceeds a peak or maximum configured/available packet processing rate or bandwidth usage supported by the network device/node or one or more packet processing components therein. Additionally, optionally or alternatively, an oversubscription or congestion event occurs when an (aggregated) incoming packet rate exceeds a packet processing rate or bandwidth usage threshold—which, for example, may represent 70% or another percentile of the peak or maximum configured/available packet processing rate—that may be used to ensure relatively high priority data traffic or services.

The ingress arbiter (maybe referred to as “IARB”) can include or implement an enqueuing/dequeuing (maybe referred to as “ENQ/DEQ”) ingress processor—with a single scheduler in the ingress arbiter in some operational scenarios—to perform intake and/or ingress arbitration operations on incoming packets received with ingress ports. The ingress arbiter or the ingress processor or scheduler therein can operate with one or more relatively deep (main) packet memory buffers—each of which may have a capacity exceeding 5+ Mbytes in some operational scenarios—to store or buffer packet data such as headers and payloads carried in the incoming packets in a lossless (e.g., uncompressed, etc.) manner.

At the time of dequeuing the buffered packets for further processing by downstream packet processing components in the same network device/nodes such as one or more ingress packet processors and one or more traffic managers, the ingress arbiter can fetch from the packet memory buffers and output the previously buffered packets to these downstream packet processing components, for example in two packet data portions for each of the packets. By way of example but not limitation, the ingress arbiter can output a first packet data portion in the form of a Start-of-packet (SOP) portion of the ingress or previously buffered packet to a downstream packet processing component to the ingress arbiter such as an ingress packet processor for making specific forwarding decisions or selecting a specific forwarding path for the ingress or incoming packet.

In addition, the ingress arbiter can output a second packet data portion in the form of a payload portion of the incoming or previously buffered packet. The payload portion may have been buffered as a part of the incoming or buffered packet in, and fetched from, a relatively deep packet memory buffer of the ingress arbiter—and outputted to a downstream packet processing component to the ingress arbiter such as a traffic manager (or an ingress arbitration block therein) until the forwarding decisions made by the ingress packet processor are received by the traffic manager and/or until further traffic management operations in connection with a specific egress port used to forward the incoming or buffered packet are to be performed for the received incoming or buffered packet.

Packets received by the ingress arbiter via the ingress ports may have varying sizes from a relatively small size such as 64 bytes to a relatively large size such as up to approximately 14 kilobytes in some cases. To store or accommodate these packets with wide size variations in the same packet memory buffers, an incoming or to-be-buffered packet may be partitioned and stored in one or more memory units of a specific size (e.g., a fixed unit size, 128 bytes, 256 bytes, etc.) in the packet memory buffers. The one or more memory units of the packet memory buffers may store one or more portions of the packet, respectively. Linking data structures including but not limited to a linked list may be used to store memory reference/address data of a set of memory units in the packet memory buffers used to different portions of the packet. The linking data structures or linked list may be used in subsequent operations such as fetching or dequeuing operations for accessing the portions of the packet that have been respectively buffered or maintained in these memory units of the packet memory buffers.

Under some approaches, the same or similar (or the same or similar types of) linking structures and/or the same or similar packet processing path or pipeline may be implemented or used by an ingress arbiter in queuing and dequeuing operations that are performed with respect to each of the incoming packets.

For example, under these approaches, when each incoming packet is received by the ingress arbiter for enqueuing, the incoming packet is to be partitioned into portions each of which may be stored in a respective memory unit of packet memory buffers. Intra-packet linking data structures may be generated or modified to store or link memory reference or address data of memory units of the packet memory buffers for the same packet. Inter-packet linking data structures may also be generated or modified to store or link different incoming packets, for example, in a specific temporal order in which the incoming packets are received.

When an incoming or buffered packet is to be dequeued for downstream packet processing components such as an ingress packet processor and/or a traffic manager, accessing one or more portions of the incoming or buffered packet may involve memory indirection operations such as accessing the generated or modified inter-packet and/or intra-packet linking data structures to determine specific memory reference/address data for the memory units that are used to buffer the portions of the incoming or buffered packet. Once the specific memory reference/address data for the memory units storing the portions of the incoming or buffered packet is determined, specific memory access portions may be accessed or retrieved. As a result, the same processing path/pipeline used by the ingress arbiter to process all incoming packets may incur relatively significant delays or time latencies due to the memory indirection operations by way of the linking data structures or linked lists.

In contrast, under techniques as described herein, when a congestion measure or indicator as determined by or with an ingress arbiter is below a system and/or user configured congestion threshold, SOP (or packet header) information of incoming or to-be-buffered packets received by the ingress arbiter via ingress ports may be stored, maintained or buffered in an accelerated memory space that is relatively small and fast (e.g., 10 k bytes, 64 k bytes, ten or hundred time smaller as compared with a packet memory buffer, etc.), whereas other parts of each of the packets are stored, maintained or buffered in a packet (memory) buffer that is larger than the small fast or accelerated memory space.

On the other hand, when the congestion measure or indicator reaches or exceeds the congestion threshold, the entire content of each of the packets may be stored, maintained or buffered in the relatively large packet (memory) buffers using a default or main ENQ/DEQ pipeline or path for the ingress traffic flows.

The accelerated memory space and the packet buffer may or may not be hosted, allocated or located in separate physical memories or devices. In some operational scenarios, the accelerated memory space and the packet buffer may be hosted, allocated or located in in the same shared physical memories or devices.

Hence, under techniques as described herein, a separate enqueuing or dequeuing path or pipeline is created for processing the incoming packet within the ingress arbitrator, when the ingress arbiter is operating in a no-congestion state—for example, the congestion measure or indicator is below the congestion threshold. Using this alternative or separate ENQ/DEQ pipeline or path, the ingress arbiter can store, maintain or buffer SOP information of an incoming packet in the accelerated memory space.

Even if packets received by the ingress arbiter via the ingress ports may have widely varying sizes, relatively fixed (e.g., up to first 100 or 128 bytes, etc.) SOP or header portions of the packets are stored in the accelerated memory space, when the ingress arbiter operates in the no-congestion state, while other parts of these packets can still be stored in the large packet memory buffers.

For example, in the no-congestion state, each SOP or header portion of each of the packets may be stored in a single memory unit and accessed or retrieved in enqueuing and dequeuing operations performed by the ingress arbiter or a scheduler therein without memory indirection and/or without using relatively large complex linking data structures or linked lists.

As a result, in the no-congestion state, delays or time latencies that would be incurred by accessing the same SOP information in the relatively large packet buffer using relatively heavy-weight linking data structures and memory reference/address indirection—for example, in the enqueuing and dequeuing operations performed by the ingress arbiter or the scheduler therein—can be much reduced using the accelerated memory space with direct memory reference/address without indirection by way of data store in the heavy-weight linking data structures used to access buffered information in the packet buffer.

Approaches, techniques, and mechanisms are disclosed for processing network packet traffic. A packet buffer of a first size and having a first memory access latency and an accelerated memory of a second size that is smaller than the first size and having a second memory access latency that is smaller than the first memory access latency are allocated in a memory space. A congestion measure for ingressing network traffic is determined. In response to determining that the congestion measure is below a congestion threshold, an ingress packet is enqueued by: storing a start-of-packet (SOP) portion of the ingress packet in the accelerated memory space; storing one or more non-SOP portions of the ingress packet in the packet buffer. In response to determining that the congestion measure is not below the congestion threshold, the ingress packet is enqueued by storing all portions of the ingress packet in the packet buffer.

Approaches, techniques, and mechanisms are disclosed for processing network packet traffic. A memory space that is divided into a packet buffer and an accelerated memory is defined. One or more congestion levels associated with ingress network traffic are determined. Upon enqueuing incoming packets, one or more memory locations are selected in the memory space for storing portions of each of the incoming packets based on at least one of the determined congestion levels.

In other aspects, the inventive subject matter encompasses computer apparatuses and/or computer-readable media configured to carry out the foregoing techniques.

### 2.0. Structural Overview

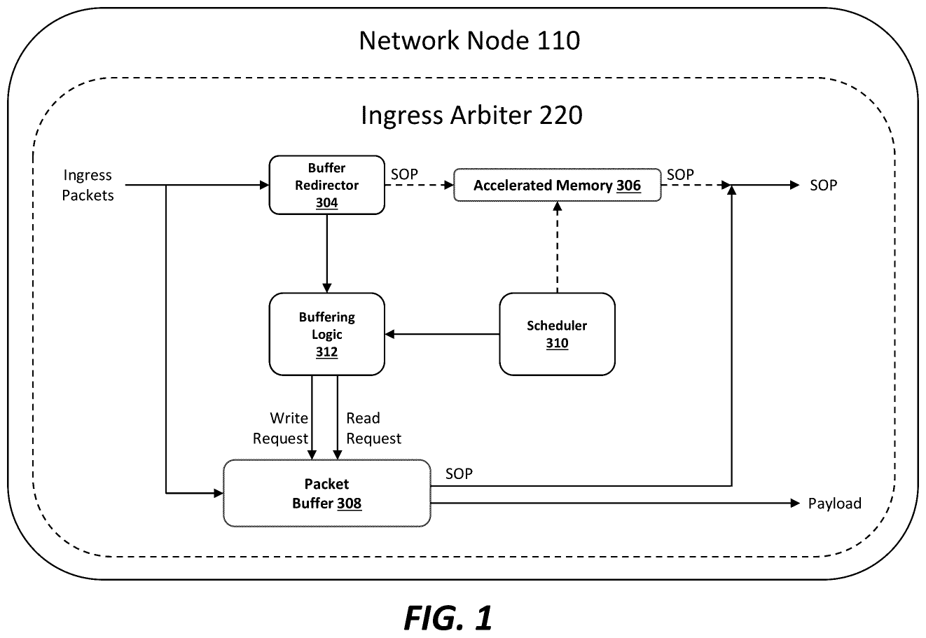

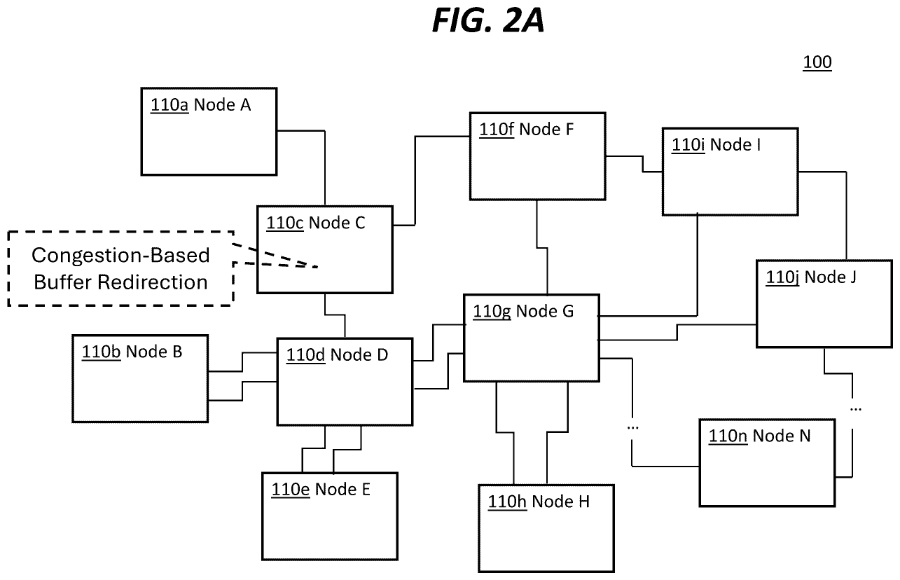

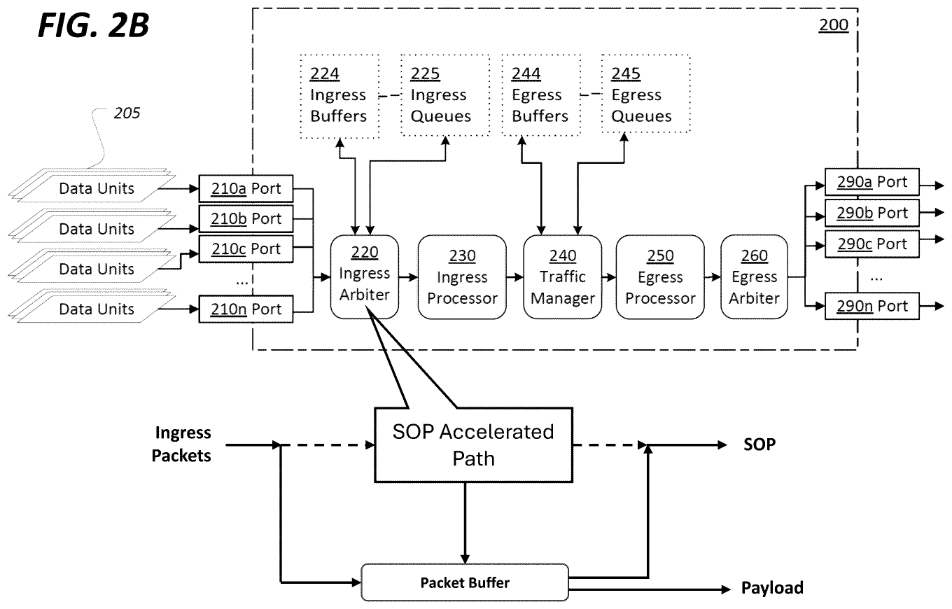

FIG. 1 illustrates an example framework for processing ingress packets using an accelerated memory of a network device/node in a communication network as described herein. For example, the network device/node (e.g., 110 of FIG. 2A, etc.) may be a single networking computing device (or a network device), such as a router or switch, in which some or all of the processing components described herein are implemented in application-specific integrated circuits (ASICs), field programmable gate arrays (FPGAs), or other integrated circuit(s). As another example, the network device/node may include one or more memories storing instructions for implementing various components described herein, one or more hardware processors configured to execute the instructions stored in the one or more memories, and various data repositories in the one or more memories for storing data structures utilized and manipulated by the various components.

As illustrated in FIG. 1, the network device/node 110 may include an ingress arbiter (e.g., 220 of FIG. 2B, etc.) operating with other packet processing components and/or resources in the network device/node 110 to process incoming packet traffic or ingress packets received via one or more ingress ports.

The ingress arbiter 220 may analyze and categorize the incoming or ingress packets and determine which processing or forwarding policies are to be applied to these ingress packets including but not limited to admitting these packets for further processing in the network device or node 110.

The ingress arbiter 220 may monitor whether there are oversubscription or congestion in the network device/node 110 or packet processing resources and components therein. For example, the ingress arbiter 220 can monitor rates at which the incoming or ingress packets are arriving. If the packet arrival rate exceeds processing capacity or link bandwidth (e.g., oversubscription, etc.) of the network device/node 110 or packet processing components therein, the ingress arbiter 220 may implement or perform flow control protocol operations (e.g., backpressure, pause frames, etc.) to prevent data loss due to the oversubscription congestion. When congestion is detected, the ingress arbiter 220 can signal upstream devices to slow down the rate of packet transmission to avoid overwhelming resources (e.g., buffers, queues, etc.) at the network device/node 110.

In some operational scenarios, the ingress arbiter 220 determines, for example based at least on comparing one or more congestion related measures/levels with one or more configured thresholds/criteria, that a separate ENQ/DEQ pipeline/path based on an accelerated memory 306 is to be invoked or used to enqueue, process and/or dequeue SOP portions of some or all of the incoming or ingress packets. In these operational scenarios, the ingress arbiter 220 may operate with a fast buffer redirect module 304 and the accelerated memory 306 to write, store, maintain or buffer the SOP portions or headers or SOP control data of the ingress or incoming packets in the smaller and faster accelerated memory 306 using the separate ENQ/DEQ pipeline or path based on the accelerated memory 306. Relative to a (default or main) ENQ/DEQ path used to write or read packet data—including but not necessarily limited to only non-SOP portions—of the same packets in enqueuing or dequeuing operations performed in the ingress arbiter 220, the separate ENQ/DEQ pipeline or path based on the accelerated memory 306 in the ingress arbiter 220 may be referred to as an alternative pipeline or path.

The default or main ENQ/DEQ path can be used by the ingress arbiter 220 to ensure packet data of some or all of the ingress packets to be buffered in a lossless manner even if the network device/node 110 or network data paths/links become congested. This lossless buffering allows these ingress packets to be stored temporarily in a packet (memory) buffer 308 until there is enough capacity to process them or forward them without any loss of data.

More specifically, in or upon enqueuing the incoming or ingress packets, the ingress arbiter 220 may operate with the fast buffer redirect module 304 and/or a buffering logic 312 (or buffer manager) to write, store, maintain or buffer at least non-SOP portions such as payloads of the incoming or ingress packets in the packet memory buffer 308, until these packets are dequeued from the ingress arbiter 220 to be sent or delivered to downstream packet processing components such as traffic manager(s) 240 and/or header merging logic engines.

In some operational scenarios, SOP portions or headers of the incoming or ingress packets may also be written, stored, maintained or buffered in the same packet buffer 308, along with the non-SOP portions such as the payloads of the incoming or ingress packets. In some other operational scenarios, writing, storing, maintaining or buffering the SOP portions or headers in the packet buffer 308 temporarily may only be performed when the ingress arbiter 220 or the fast buffer redirector 304 detects that a congestion event or condition has occurred.

Given there may be time consuming operations—including but not limited to SOP lookup and analysis operations—to be performed in connection with the SOP portions or headers of the ingress or incoming packets, SOP or related processing operations may dictate or dominate overall time delays or latencies incurred in overall packet processing operations of the ingress or incoming packets in the ingress arbiter 220. In the ingress arbiter 220 as described herein, SOP acceleration may be achieved by using an accelerated memory 306—of relatively small size and fast memory access (e.g., with relatively low time latency, etc.) as compared with the packet buffer 308—and an (alternate or additional or bifurcated) ENQ/DEQ pipeline or path based on the accelerated memory 306.

For example, the ingress arbiter 220 may include or operate with a scheduler 310 (or ingress processor) to perform some or all dequeuing operations with respect to the ingress or incoming packets. The scheduler 310 may be implemented, configured or used to schedule and perform dequeuing the SOP portions or headers or SOP control data from one or both of the accelerated memory 306 and the packet buffer 308.

More specifically, when the alternative ENQ/DEQ is in operation, to dequeue an ingress or buffered packet, the scheduler 310 may cause the SOP portion or header of the packet to be fetched from the accelerate memory 306 with relatively low delay or latency. In comparison, when the alternative ENQ/DEQ is not in operation (e.g., due to oversubscription or congestion, etc.), the scheduler 310 may operate with the buffering logic 312 (or buffer manager) to use inter-packet and/or intra-packet linking data structures such as memory address linked lists to read the SOP portion or header from the packet buffer 308 with relatively large delay or latency. The SOP portion or header or SOP control data from one or both of the accelerated memory 306 may be arbitrated by an arbitration logic (denoted as “ARB”) before the SOP portion or header or SOP control data is outputted to downstream packet processing logic engines in the network device/node 110 such as an ingress packet processor 230, an egress packet processor 250, etc. The ingress processor 230 may use the SOP portion or header or SOP control data from the ingress arbiter 220 to make forwarding decisions for the ingress or incoming packet.

In the meantime, to dequeue the ingress or incoming packet, the scheduler 310 may operate with the buffering logic 312 (or buffer manager) to use the same inter-packet and/or intra-packet linking data structures or memory address linked lists to read buffered packet data—including but not necessarily limited to only non-SOP (or non-header) portions—of the ingress or incoming packet from the packet buffer 308, and output the packet data of the ingress or incoming packet to downstream packet processing logic engines in the network device/node 110 such as a traffic manager 240, which may receive the forwarding decisions from the ingress packet processor 230 and operate with an egress packet processor 250 to forward an outgoing packet corresponding to the ingress packet out of a specific egress port 290 in a specific network path to a next hop network device or node.

### 3.0. Packet Communication Network

FIG. 2A illustrates example aspects of an example networking system 100, also referred to as a network, in which the techniques described herein may be practiced, according to an embodiment. Networking system 100 comprises a plurality of interconnected nodes 110a-110n (collectively nodes 110), each implemented by a different computing device. For example, a node 110 may be a single networking computing device (or a network device), such as a router or switch, in which some or all of the processing components described herein are implemented in application-specific integrated circuits (ASICs), field programmable gate arrays (FPGAs), or other integrated circuit(s). As another example, a node 110 may include one or more memories (e.g., non-transitory computer-readable media, etc.) storing instructions for implementing various components described herein, one or more hardware processors configured to execute the instructions stored in the one or more memories, and various data repositories in the one or more memories for storing data structures utilized and manipulated by the various components.

Each node 110 is connected to one or more other nodes 110 in network 100 by one or more communication links, depicted as lines between nodes 110. The communication links may be any suitable wired cabling or wireless links. Note that system 100 illustrates only one of many possible arrangements of nodes within a network. Other networks may include fewer or additional nodes 110 having any number of links between them.

While each node 110 may or may not have a variety of other functions, in an embodiment, each node 110 is configured to send, receive, and/or relay data to one or more other nodes 110 via these links. In general, data is communicated as series of discrete units or structures of data represented by signals transmitted over the communication links. As illustrated in FIG. 2A, some or all of the nodes including, but not necessarily limited to only, node 100c may implement some or all congestion based ingress arbitration techniques as described herein (with super or relatively low latency).

### 3.1. Packets and Other Data Units

Different nodes 110 within a network 100 may send, receive, and/or relay data units at different communication levels, or layers. For instance, a first node 110 may send a data unit at the network layer (e.g., a TCP segment, IP packet, etc.) to a second node 110 over a path that includes an intermediate node 110. This data unit will be broken into smaller data units at various sublevels before it is transmitted from the first node 110. These smaller data units may be referred to as “subunits” or “portions” of the larger data unit.

For example, the data unit may be sent in one or more of: packets, cells, collections of signal-encoded bits, etc., to the intermediate node 110. Depending on the network type and/or the device type of the intermediate node 110, the intermediate node 110 may rebuild the entire original data unit before routing the information to the second node 110, or the intermediate node 110 may simply rebuild certain subunits of the data (e.g., frames and/or cells) and route those subunits to the second node 110 without ever composing the entire original data unit.

When a node 110 receives a data unit, it typically examines addressing information within the data unit (and/or other information within the data unit) to determine how to process the data unit. The addressing information may be, for instance, an Internet Protocol (IP) address, MPLS label, or any other suitable information. If the addressing information indicates that the receiving node 110 is not the destination for the data unit, the receiving node 110 may look up the destination node 110 within receiving node's routing information and route the data unit to another node 110 connected to the receiving node 110 based on forwarding instructions associated with the destination node 110 (or an address group to which the destination node belongs). The forwarding instructions may indicate, for instance, an outgoing port over which to send the data unit, a label to attach the data unit, a next hop, etc. In cases where multiple (e.g., equal-cost, non-equal-cost, etc.) paths to the destination node 110 are possible, the forwarding instructions may include information indicating a suitable approach for selecting one of those paths, or a path deemed to be the best path may already be defined.

Addressing information, flags, labels, and other metadata used for determining how to handle a data unit are typically embedded within a portion of the data unit known as the header. The header typically is located at the beginning of the data unit, and is followed by the payload of the data unit, which is the information actually being sent in the data unit. A header typically is comprised of fields of different types, such as a destination address field, source address field, destination port field, source port field, and so forth. In some protocols, the number and the arrangement of fields may be fixed. Other protocols allow for arbitrary numbers of fields, with some or all of the fields being preceded by type information that explains to a node the meaning of the field.

A traffic flow is a sequence of data units, such as packets, with common attributes, typically being from a same source to a same destination. In an embodiment, the source of the traffic flow may mark each data unit in the sequence as a member of the flow using a label, tag, or other suitable identifier within the data unit. In another embodiment, the flow is identified by deriving an identifier from other fields in the data unit (e.g., a “five-tuple” or “5-tupple” combination of a source address, source port, destination address, destination port, and protocol). A flow is often intended to be sent in sequence, and network devices may therefore be configured to send all data units within a given flow along a same path to ensure that the flow is received in sequence.

Data units may be single-destination or multi-destination. Single-destination data units are typically unicast data units, specifying only a single destination address. Multi-destination data units are often multicast data units, specifying multiple destination addresses, or addresses shared by multiple destinations. However, a given node may in some circumstances treat unicast data units as having multiple destinations. For example, the node may be configured to mirror a data unit to another port such as a law enforcement port or debug port, copy the data unit to a central processing unit for diagnostic purposes or suspicious activity, recirculate a data unit, or take other actions that cause a unicast data unit to be sent to multiple destinations. By the same token, a given data unit may in some circumstances treat a multicast data unit as a single-destination data unit, if, for example all destinations targeted by the data unit are reachable by the same egress port.

For convenience, many of the techniques described in this disclosure are described with respect to routing data units that are IP packets in an L3 (level/layer 3) network, or routing the constituent cells and frames thereof in an L2 (level/layer 2) network, in which contexts the described techniques have particular advantages. It is noted, however, that these techniques may also be applied to realize advantages in routing other types of data units conforming to other protocols and/or at other communication layers within a network. Thus, unless otherwise stated or apparent, the techniques described herein should also be understood to apply to contexts in which the “data units” are of any other type of data structure communicated across a network, such as segments or datagrams. That is, in these contexts, other types of data structures may be used in place of packets, cells, frames, and so forth.

It is noted that the actual physical representation of a data unit may change as a result of the processes described herein. For instance, a data unit may be converted from a physical representation at a particular location in one memory to a signal-based representation, and back to a physical representation at a different location in a potentially different memory, as it is moved from one component to another within a network device or even between network devices. Such movement may technically involve deleting, converting, and/or copying some or all of the data unit any number of times. For simplification, however, the data unit is logically said to remain the same data unit as it moves through the device, even if the physical representation of the data unit changes. Similarly, the contents and/or structure of a data unit may change as it is processed, such as by adding or deleting header information, adjusting cell boundaries, or even modifying payload data. A modified data unit is nonetheless still said to be the same data unit, even after altering its contents and/or structure.

### 3.2. Network Paths

Any node in the depicted network 100 may communicate with any other node in the network 100 by sending data units through a series of nodes 110 and links, referred to as a path. For example, Node B (110b) may send data units to Node H (110h) via a path from Node B to Node D to Node E to Node H. There may be a large number of valid paths between two nodes. For example, another path from Node B to Node H is from Node B to Node D to Node G to Node H.

In an embodiment, a node 110 does not actually need to specify a full path for a data unit that it sends. Rather, the node 110 may simply be configured to calculate the best path for the data unit out of the device (e.g., which egress port it should send the data unit out on, etc.). When a node 110 receives a data unit that is not addressed directly to the node 110, based on header information associated with a data unit, such as path and/or destination information, the node 110 relays the data unit along to either the destination node 110, or a “next hop” node 110 that the node 110 calculates is in a better position to relay the data unit to the destination node 110. In this manner, the actual path of a data unit is product of each node 110 along the path making routing decisions about how best to move the data unit along to the destination node 110 identified by the data unit.

### 4.0. Network Device

FIG. 2B illustrates example aspects of an example network device 200 in which techniques described herein may be practiced, according to an embodiment. Network device 200 is a computing device comprising any combination of hardware and software configured to implement the various logical components described herein, including components 210-290. For example, the apparatus may be a single networking computing device, such as a router or switch, in which some or all of the components 210-290 described herein are implemented using application-specific integrated circuits (ASICs). As another example, an implementing apparatus may include one or more memories storing instructions for implementing various components described herein, one or more hardware processors configured to execute the instructions stored in the one or more memories, and various data repositories in the one or more memories for storing data structures utilized and manipulated by various components 210-290.

Device 200 is generally configured to receive and forward data units 205 to other devices in a network, such as network 100, by means of a series of operations performed at various components within the device 200. Note that, in an embodiment, some or all of the nodes 110 in system 100 may each be or include a separate network device 200. In an embodiment, a node 110 may include more than one device 200. In an embodiment, device 200 may itself be one of a number of components within a node 110. For instance, network device 200 may be an integrated circuit, or “chip,” dedicated to performing switching and/or routing functions within a network switch or router. The network switch or router further comprises one or more central processor units, storage units, memories, physical interfaces, LED displays, or other components external to the chip, some or all of which may communicate with the chip, in an embodiment.

A non-limiting example flow of a data unit 205 through various subcomponents of the forwarding logic of device 200 is as follows. After being received via a port 210, a data unit 205 may be buffered in an ingress buffer 224 and queued in an ingress queue 225 by an ingress arbiter 220 until the data unit 205 can be processed by an ingress packet processor 230, and then delivered to an interconnect (or a cross connect) such as a switching fabric. From the interconnect, the data unit 205 may be forwarded to a traffic manager 240. The traffic manager 240 may store the data unit 205 in an egress buffer 244 and assign the data unit 205 to an egress queue 245. The traffic manager 240 manages the flow of the data unit 205 through the egress queue 245 until the data unit 205 is released to an egress packet processor 250. Depending on the processing, the traffic manager 240 may then assign the data unit 205 to another queue so that it may be processed by yet another egress processor 250, or the egress packet processor 250 may send the data unit 205 to an egress arbiter 260 which temporally stores or buffers the data unit 205 in a transmit buffer and finally forwards out the data unit via another port 290. Of course, depending on the embodiment, the forwarding logic may omit some of these subcomponents and/or include other subcomponents in varying arrangements.

Example components of a device 200 are now described in further detail.

### 4.1. Ports

Network device 200 includes ports 210/290. Ports 210, including ports 210-1 through 210-N, are inbound (“ingress”) ports by which data units referred to herein as data units 205 are received over a network, such as network 110. Ports 290, including ports 290-1 through 290-N, are outbound (“egress”) ports by which at least some of the data units 205 are sent out to other destinations within the network, after having been processed by the network device 200.

Egress ports 290 may operate with corresponding transmit buffers to store data units or subunits (e.g., packets, cells, frames, transmission units, etc.) divided therefrom that are to be transmitted through ports 290. Transmit buffers may have one-to-one correspondence relationships with ports 290, many-to-one correspondence with ports 290, and so on. Egress processors 250 or egress arbiters 260 operating with egress processors 250 may output these data units or subunits to transmit buffers before these units/subunits are transmitted out from ports 290.

Data units 205 may be of any suitable PDU type, such as packets, cells, frames, transmission units, etc. In an embodiment, data units 205 are packets. However, the individual atomic data units upon which the depicted components may operate may actually be subunits of the data units 205. For example, data units 205 may be received, acted upon, and transmitted at a cell or frame level. These cells or frames may be logically linked together as the data units 205 (e.g., packets, etc.) to which they respectively belong for purposes of determining how to handle the cells or frames. However, the subunits may not actually be assembled into data units 205 within device 200, particularly if the subunits are being forwarded to another destination through device 200.

Ports 210/290 are depicted as separate ports for illustrative purposes, but may actually correspond to the same physical hardware ports (e.g., network jacks or interfaces, etc.) on the network device 210. That is, a network device 200 may both receive data units 205 and send data units 205 over a single physical port, and the single physical port may thus function as both an ingress port 210 (e.g., one of 210a, 210b, 210c, . . . 210n, etc.) and egress port 290. Nonetheless, for various functional purposes, certain logic of the network device 200 may view a single physical port as a separate ingress port 210 and a separate egress port 290. Moreover, for various functional purposes, certain logic of the network device 200 may subdivide a single physical ingress port or egress port into multiple ingress ports 210 or egress ports 290, or aggregate multiple physical ingress ports or egress ports into a single ingress port 210 or egress port 290. Hence, in some operational scenarios, ports 210 and 290 should be understood as distinct logical constructs that are mapped to physical ports rather than simply as distinct physical constructs.

In some embodiments, the ports 210/290 of a device 200 may be coupled to one or more transceivers, such as Serializer/Deserializer (“SerDes”) blocks. For instance, ports 210 may provide parallel inputs of received data units into a SerDes block, which then outputs the data units serially into an ingress packet processor 230. On the other end, an egress packet processor 250 may input data units serially into another SerDes block, which outputs the data units in parallel to ports 290.

### 4.2. Packet Processors

A device 200 comprises one or more packet processing components that collectively implement forwarding logic by which the device 200 is configured to determine how to handle each data unit 205 that is received at device 200. These packet processors components may be any suitable combination of fixed circuitry and/or software-based logic, such as specific logic components implemented by one or more Field Programmable Gate Arrays (FPGAs) or Application-Specific Integrated Circuits (ASICs), or a general-purpose processor executing software instructions.

Different packet processors 230 and 250 may be configured to perform different packet processing tasks. These tasks may include, for example, identifying paths along which to forward data units 205, forwarding data units 205 to egress ports 290, implementing flow control and/or other policies, manipulating packets, performing statistical or debugging operations, and so forth. A device 200 may comprise any number of packet processors 230 and 250 configured to perform any number of processing tasks.

In an embodiment, the packet processors 230 and 250 within a device 200 may be arranged such that the output of one packet processor 230 or 250 may, eventually, be inputted into another packet processor 230 or 250, in such a manner as to pass data units 205 from certain packet processor(s) 230 and/or 250 to other packet processor(s) 230 and/or 250 in a sequence of stages, until finally disposing of the data units 205 (e.g., by sending the data units 205 out an egress port 290, “dropping” the data units 205, etc.). The exact set and/or sequence of packet processors 230 and/or 250 that process a given data unit 205 may vary, in some embodiments, depending on the attributes of the data unit 205 and/or the state of the device 200. There is no limit to the number of packet processors 230 and/or 250 that may be chained together in such a manner.

Based on decisions made while processing a data unit 205, a packet processor 230 or 250 may, in some embodiments, and/or for certain processing tasks, manipulate a data unit 205 directly. For instance, the packet processor 230 or 250 may add, delete, or modify information in a data unit header or payload. In other embodiments, and/or for other processing tasks, a packet processor 230 or 250 may generate control information that accompanies the data unit 205, or is merged with the data unit 205, as the data unit 205 continues through the device 200. This control information may then be utilized by other components of the device 200 to implement decisions made by the packet processor 230 or 250. In some operational scenarios, the data unit that is actually processed through a processing pipeline—while the original payload and header are stored in memory—may be referred to as a descriptor (or a template).

In an embodiment, a packet processor 230 or 250 need not necessarily process an entire data unit 205, but may rather only receive and process a subunit of a data unit 205 comprising header information for the data unit. For instance, if the data unit 205 is a packet comprising multiple cells, the first cell, or a first subset of cells, might be forwarded to a packet processor 230 or 250, while the remaining cells of the packet (and potentially the first cell(s) as well) are forwarded in parallel to a merger component where they await results of the processing.

In an embodiment, a packet processor may be generally classified as an ingress packet processor 230 or an egress packet processor 250. Generally, an ingress processor 230 resolves destinations for a traffic manager 240 to determine which egress ports 290 (e.g., one of 290a, 290b, 290c, . . . 290n, etc.) and/or queues a data unit 205 should depart from. There may be any number of ingress processors 230, including just a single ingress processor 230.

In an embodiment, an ingress processor 230 performs certain intake tasks on data units 205 as they arrive. These intake tasks may include, for instance, and without limitation, parsing data units 205, performing routing related lookup operations, categorically blocking data units 205 with certain attributes and/or when the device 200 is in a certain state, duplicating certain types of data units 205, making initial categorizations of data units 205, and so forth. Once the appropriate intake task(s) have been performed, the data units 205 are forwarded to an appropriate traffic manager 240, to which the ingress processor 230 may be coupled directly or via various other components, such as an interconnect component.

The egress packet processor(s) 250 of a device 200, by contrast, may be configured to perform non-intake tasks necessary to implement the forwarding logic of the device 200. These tasks may include, for example, tasks such as identifying paths along which to forward the data units 205, implementing flow control and/or other policies, manipulating data units, performing statistical or debugging operations, and so forth. In an embodiment, there may be different egress packet processors(s) 250 assigned to different flows or other categories of traffic, such that not all data units 205 will be processed by the same egress packet processor 250.

In an embodiment, each egress processor 250 is coupled to a different group of egress ports 290 to which they may send data units 205 processed by the egress processor 250. In an embodiment, access to a group of ports 290 or corresponding transmit buffers for the ports 290 may be regulated via an egress arbiter 260 coupled to the egress packet processor 250. In some embodiments, an egress processor 250 may also or instead be coupled to other potential destinations, such as an internal central processing unit, a storage subsystem, or a traffic manager 240.

### 4.3. Buffers

Since not all data units 205 received by the device 200 can be processed by component(s) such as the packet processor(s) 230 and/or 250 and/or ports 290 at the same time, various components of device 200 may temporarily store data units 205 in memory structures referred to as (e.g., ingress, egress, etc.) buffers while the data units 205 are waiting to be processed. For example, a certain packet processor 230 or 250 or port 290 may only be capable of processing a certain amount of data such as a certain number of data units 205, or portions of data units 205, in a given clock cycle, meaning that other data units 205, or portions of data units 205, destined for the packet processor 230 or 250 or port 290 must either be ignored (e.g., dropped, etc.) or stored. At any given time, a large number of data units 205 may be stored in the buffers of the device 200, depending on network traffic conditions.

A device 200 may include a variety of buffers, each utilized for varying purposes and/or components. Generally, a data unit 205 awaiting processing by a component is held in a buffer associated with that component until the data unit 205 is “released” to the component for processing.

Buffers may be implemented using any number of distinct banks of memory. Each bank may be a portion of any type of memory, including volatile memory and/or non-volatile memory. In an embodiment, each bank comprises many addressable “entries” (e.g., rows, columns, etc.) in which data units 205, subunits, linking data, or other types of data, may be stored. The size of each entry in a given bank is known as the “width” of the bank, while the number of entries in the bank is known as the “depth” of the bank. The number of banks may vary depending on the embodiment.

Each bank may have associated access limitations. For instance, a bank may be implemented using single-ported memories that may only be accessed once in a given time slot (e.g., clock cycle, etc.). Hence, the device 200 may be configured to ensure that no more than one entry need be read from or written to the bank in a given time slot. A bank may instead be implemented in a multi-ported memory to support two or more accesses in a given time slot. However, single-ported memories may be desirable in many cases for higher operating frequencies and/or reducing costs.

In an embodiment, in addition to buffer banks, a device may be configured to aggregate certain banks together into logical banks that support additional reads or writes in a time slot and/or higher write bandwidth. In an embodiment, each bank, whether logical or physical or of another (e.g., addressable, hierarchical, multi-level, sub bank, etc.) organization structure, is capable of being accessed concurrently with each other bank in a same clock cycle, though full realization of this capability is not necessary.

Some or all of the components in device 200 that utilize one or more buffers may include a buffer manager configured to manage use of those buffer(s). Among other processing tasks, the buffer manager may, for example, maintain a mapping of data units 205 to buffer entries in which data for those data units 205 is stored, determine when a data unit 205 must be dropped because it cannot be stored in a buffer, perform garbage collection on buffer entries for data units 205 (or portions thereof) that are no longer needed, and so forth.

A buffer manager may include buffer assignment logic. The buffer assignment logic is configured to identify which buffer entry or entries should be utilized to store a given data unit 205, or portion thereof. In some embodiments, each data unit 205 is stored in a single entry. In yet other embodiments, a data unit 205 is received as, or divided into, constituent data unit portions for storage purposes. The buffers may store these constituent portions separately (e.g., not at the same address location or even within the same bank, etc.). The one or more buffer entries in which a data unit 205 are stored are marked as utilized (e.g., in a “free” list, free or available if not marked as utilized, etc.) to prevent newly received data units 205 from overwriting data units 205 that are already buffered. After a data unit 205 is released from the buffer, the one or more entries in which the data unit 205 is buffered may then be marked as available for storing new data units 205.

In some embodiments, the buffer assignment logic is relatively simple, in that data units 205 or data unit portions are assigned to banks and/or specific entries within those banks randomly or using a round-robin approach. In some embodiments, data units 205 are assigned to buffers at least partially based on characteristics of those data units 205, such as corresponding traffic flows, destination addresses, source addresses, ingress ports, and/or other metadata. For example, different banks may be utilized to store data units 205 received from different ports 210 or sets of ports 210. In an embodiment, the buffer assignment logic also or instead utilizes buffer state information, such as utilization metrics, to determine which bank and/or buffer entry to assign to a data unit 205, or portion thereof. Other assignment considerations may include buffer assignment rules (e.g., no writing two consecutive cells from the same packet to the same bank, etc.) and I/O scheduling conflicts, for example, to avoid assigning a data unit to a bank when there are no available write operations to that bank on account of other components reading content already in the bank.

### 4.4. Queues

In an embodiment, to manage the order in which data units 205 are processed from the buffers, various components of a device 200 may implement queueing logic. For example, the flow of data units through ingress buffers 224 may be managed using ingress queues 225 while the flow of data units through egress buffers 244 may be managed using egress queues 245.

Each data unit 205, or the buffer locations(s) in which the data unit 205 is stored, is said to belong to one or more constructs referred to as queues. Typically, a queue is a set of memory locations (e.g., in the buffers 224 and/or 244, etc.) arranged in some order by metadata describing the queue. The memory locations may (and often are) non-contiguous relative to their addressing scheme and/or physical or logical arrangement. For example, the metadata for one queue may indicate that the queue is comprised of, in order, entry addresses 2, 50, 3, and 82 in a certain buffer.

In various embodiments, the sequence in which the queue arranges its constituent data units 205 generally corresponds to the order in which the data units 205 or data unit portions in the queue will be released and processed. Such queues are known as first-in-first-out (“FIFO”) queues, though in other embodiments other types of queues may be utilized. In some embodiments, the number of data units 205 or data unit portions assigned to a given queue at a given time may be limited, either globally or on a per-queue basis, and this limit may change over time.

### 4.5. Traffic Manager

According to an embodiment, a device 200 further includes one or more traffic managers 240 configured to control the flow of data units to one or more packet processor(s) 230 and/or 250. For instance, a buffer manager (or buffer allocation logic) within the traffic manager 240 may temporarily store data units 205 in buffers 244 as they await processing by egress processor(s) 250. A traffic manager 240 may receive data units 205 directly from a port 210, from an ingress processor 230, and/or other suitable components of device 200. In an embodiment, the traffic manager 240 receives one TDU from each possible source (e.g. each port 210, etc.) each clock cycle or other time slot.

Traffic manager 240 may include or be coupled to egress buffers 244 for buffering data units 205 prior to sending those data units 205 to their respective egress processor(s) 250. A buffer manager within the traffic manager 240 may temporarily store data units 205 in egress buffers 244 as they await processing by egress processor(s) 250. The number of egress buffers 244 may vary depending on the embodiment. A data unit 205 or data unit portion in an egress buffer 244 may eventually be “released” to one or more egress processor(s) 250 for processing, by reading the data unit 205 from the (e.g., egress, etc.) buffer 244 and sending the data unit 205 to the egress processor(s) 250. In an embodiment, traffic manager 240 may release up to a certain number of data units 205 from buffers 244 to egress processors 250 each clock cycle or other defined time slot.

Beyond managing the use of buffers 244 to store data units 205 (or copies thereof), a traffic manager 240 may include queue management logic configured to assign buffer entries to queues and manage the flow of data units 205 through the queues. The traffic manager 240 may, for instance, identify a specific queue to assign a data unit 205 to upon receipt of the data unit 205. The traffic manager 240 may further determine when to release—also referred to as “dequeuing”—data units 205 (or portions thereof) from queues and provide those data units 205 to specific packet processor(s) 250. Buffer management logic in the traffic manager 240 may further “deallocate” entries in a buffer 244 that store data units 205 are no longer linked to the traffic manager's queues. These entries are then reclaimed for use in storing new data through a garbage collection process.

In an embodiment, different queues may exist for different destinations. For example, each port 210 and/or port 290 may have its own set of queues. The queue to which an incoming data unit 205 is assigned and linked may, for instance, be selected based on forwarding information indicating which port 290 the data unit 205 should depart from. In an embodiment, a different egress processor 250 may be associated with each different set of one or more queues. In an embodiment, the current processing context of the data unit 205 may be used to select which queue a data unit 205 should be assigned to.

In an embodiment, there may also or instead be different queues for different flows or sets of flows. That is, each identifiable traffic flow or group of traffic flows is assigned its own set of queues to which its data units 205 are respectively assigned.

Device 200 may comprise any number (e.g., one or more, etc.) of packet processors 230 and/or 250 and traffic managers 240. For instance, different sets of ports 210 and/or ports 290 may have their own traffic manager 240 and packet processors 230 and/or 250. As another example, in an embodiment, the traffic manager 240 may be duplicated for some or all of the stages of processing a data unit. For example, system 200 may include a traffic manager 240 and egress packet processor 250 for an egress stage performed upon the data unit 205 exiting the system 200, and/or a traffic manager 240 and packet processor 230 or 250 for any number of intermediate stages. The data unit 205 may thus pass through any number of traffic managers 240 and/or packet processors 230 and/or 250 prior to exiting the system 200.

In an embodiment, a traffic manager 240 is coupled to the ingress packet processor(s) 230, such that data units 205 (or portions thereof) are assigned to buffers only upon being initially processed by an ingress packet processor 230. Once in an egress buffer 244, a data unit 205 (or portion thereof) may be “released” to one or more egress packet processor(s) 250 for processing, either by the traffic manager 240 sending a link or other suitable addressing information for the corresponding buffer 244 to the egress packet processor 250, or by sending the data unit 205 directly.

In the course of processing a data unit 205, a device 200 may replicate a data unit 205 one or more times for purposes such as, without limitation, multicasting, mirroring, debugging, and so forth. For example, a single data unit 205 may be replicated to multiple egress queues 245. Any given copy of the data unit may be treated as a received packet to be routed or forwarded with a multi-path group under techniques as described herein. For instance, a data unit 205 may be linked to separate queues for each of ports 1, 3, and 5. As another example, a data unit 205 may be replicated a number of times after it reaches the head of a queue (e.g., for different egress processors 250, etc.). Hence, though certain techniques described herein may refer to the original data unit 205 that was received by the device 200, it is noted that those techniques will equally apply to copies of the data unit 205 that have been generated for various purposes. A copy of a data unit 205 may be partial or complete. Moreover, there may be an actual copy of the data unit 205 in buffers, or a single copy of the data unit 205 may be linked from a single buffer location to multiple queues at the same time.

An ingress arbiter 220 may implement a separate SOP accelerated enqueuing and dequeuing path—for SOP portions or headers of incoming or ingress packets—that is separate from a packet buffer and a default or main path based on the packet buffer. The default or main path can be used to enqueue, buffer and dequeue packet data including at least non-SOP portions such as payloads of the ingress packets.

The separate SOP accelerated path in addition to the default or main path may be used to significantly reduce relatively large delays or latencies in processing the SOP portions or headers of the incoming or ingress packets when the ingress arbiter 220 is not operating in an oversubscription or congestion state.

Downstream packet processing components such as traffic manager(s) 230 or header merging logic engines can still receive payloads of the ingress packets by way of the default or main path.

### 4.6. Forwarding Logic

The logic by which a device 200 determines how to handle a data unit 205—such as where and whether to send a data unit 205, whether to perform additional processing on a data unit 205, etc.—is referred to as the forwarding logic of the device 200. This forwarding logic is collectively implemented by a variety of the components of the device 200, such as described above. For example, an ingress packet processor 230 may be responsible for resolving the destination of a data unit 205 and determining the set of actions/edits to perform on the data unit 205, and an egress packet processor 250 may perform the edits. Or, the egress packet processor 250 may also determine actions and resolve a destination in some cases. Also, there may be embodiments when the ingress packet processor 230 performs edits as well.

The forwarding logic may be hard-coded and/or configurable, depending on the embodiment. For example, the forwarding logic of a device 200, or portions thereof, may, in some instances, be at least partially hard-coded into one or more ingress processors 230 and/or egress processors 250. As another example, the forwarding logic, or elements thereof, may also be configurable, in that the logic changes over time in response to analyses of state information collected from, or instructions received from, the various components of the device 200 and/or other nodes in the network in which the device 200 is located.

In an embodiment, a device 200 will typically store in its memories one or more forwarding tables (or equivalent structures) that map certain data unit attributes or characteristics to actions to be taken with respect to data units 205 having those attributes or characteristics, such as sending a data unit 205 to a selected path, or processing the data unit 205 using a specified internal component. For instance, such attributes or characteristics may include a Quality-of-Service level specified by the data unit 205 or associated with another characteristic of the data unit 205, a flow control group, an ingress port 210 through which the data unit 205 was received, a tag or label in a packet's header, a source address, a destination address, a packet type, or any other suitable distinguishing property. A traffic manager 240 may, for example, implement logic that reads such a table, determines one or more ports 290 to send a data unit 205 to based on the table, and sends the data unit 205 to an egress processor 250 that is coupled to the one or more ports 290.

According to an embodiment, the forwarding tables describe groups of one or more addresses, such as subnets of IPv4 or IPv6 addresses. Each address is an address of a network device on a network, though a network device may have more than one address. Each group is associated with a potentially different set of one or more actions to execute with respect to data units that resolve to (e.g., are directed to, etc.) an address within the group. Any suitable set of one or more actions may be associated with a group of addresses, including without limitation, forwarding a message to a specified “next hop,” duplicating the message, changing the destination of the message, dropping the message, performing debugging or statistical operations, applying a quality of service policy or flow control policy, and so forth.

For illustrative purposes, these tables are described as “forwarding tables,” though it will be noted that the extent of the action(s) described by the tables may be much greater than simply where to forward the message. For example, in an embodiment, a table may be a basic forwarding table that simply specifies a next hop for each group. In other embodiments, a table may describe one or more complex policies for each group. Moreover, there may be different types of tables for different purposes. For instance, one table may be a basic forwarding table that is compared to the destination address of each packet, while another table may specify policies to apply to packets upon ingress based on their destination (or source) group, and so forth.

In an embodiment, forwarding logic may read port state data for ports 210/290. Port state data may include, for instance, flow control state information describing various traffic flows and associated traffic flow control rules or policies, link status information indicating links that are up or down, port utilization information indicating how ports are being utilized (e.g., utilization percentages, utilization states, etc.). Forwarding logic may be configured to implement the associated rules or policies associated with the flow(s) to which a given packet belongs.

As data units 205 are routed through different nodes in a network, the nodes may, on occasion, discard, fail to send, or fail to receive certain data units 205, thus resulting in the data units 205 failing to reach their intended destination. The act of discarding of a data unit 205, or failing to deliver a data unit 205, is typically referred to as “dropping” the data unit. Instances of dropping a data unit 205, referred to herein as “drops” or “packet loss,” may occur for a variety of reasons, such as resource limitations, errors, or deliberate policies. Different components of a device 200 may make the decision to drop a data unit 205 for various reasons. For instance, a traffic manager 240 may determine to drop a data unit 205 because, among other reasons, buffers are overutilized, a queue is over a certain size, and/or a data unit 205 has a certain characteristic.

### 5.0. Low Latency Ingress Arbitration

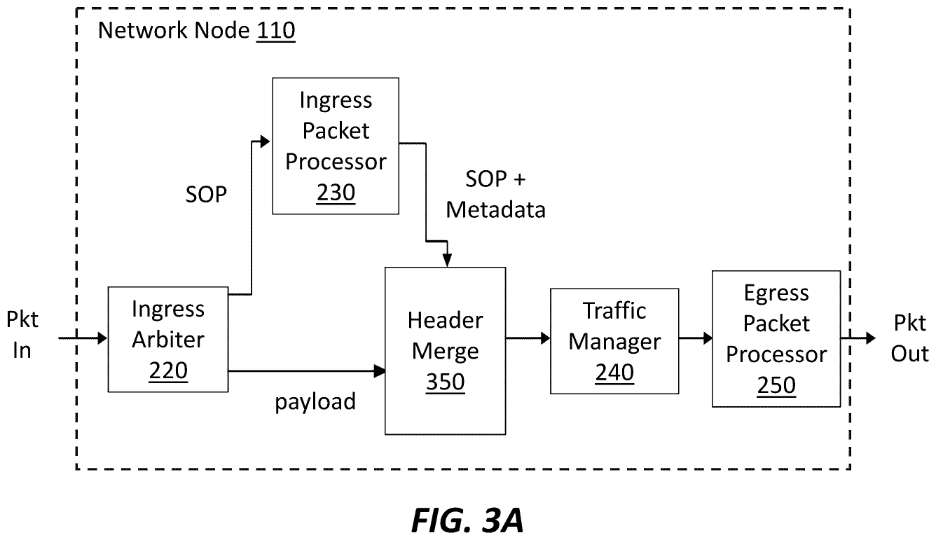

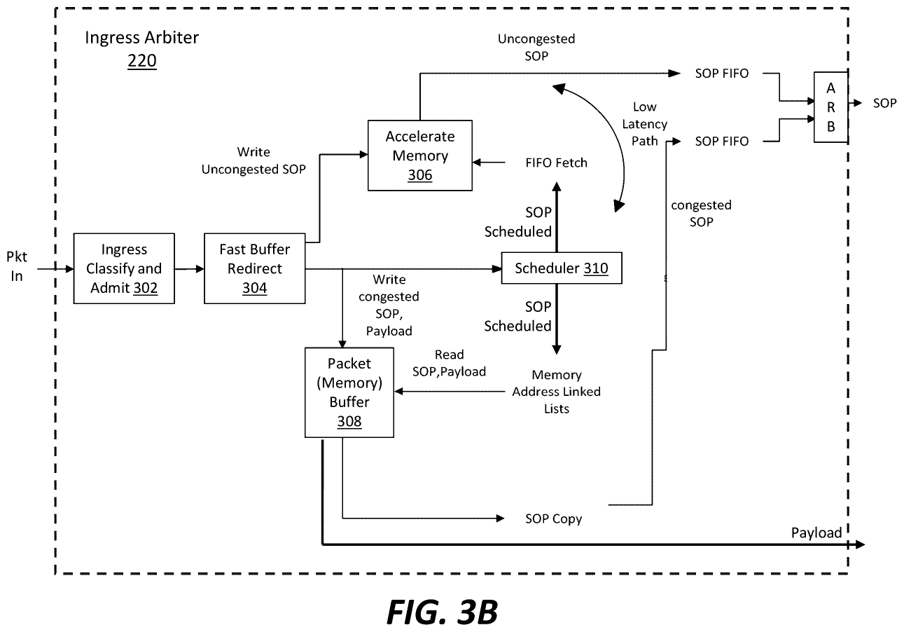

FIG. 3A illustrates example packet processing operations performed by a network device/node or packet processing components therein in a communication network as described herein. For example, the network device/node (e.g., 110 of FIG. 2A, etc.) may be a single networking computing device (or a network device), such as a router or switch, in which some or all of the processing components described herein are implemented in application-specific integrated circuits (ASICs), field programmable gate arrays (FPGAs), or other integrated circuit(s). As another example, the network device/node 110 may include one or more memories storing instructions for implementing various components described herein, one or more hardware processors configured to execute the instructions stored in the one or more memories, and various data repositories in the one or more memories for storing data structures utilized and manipulated by the various components.

In many operational scenarios, an ingress arbiter 220 may be configured to perform buffering of lossless inflight data and manage packet rate oversubscription and/or congestion events. An oversubscription or congestion event occurs when an (aggregated) incoming packet rate exceeds a peak or maximum configured/available packet processing rate or bandwidth usage supported by the network device/node 110 or one or more packet processing components therein. Additionally, optionally or alternatively, an oversubscription or congestion event occurs when an (aggregated) incoming packet rate exceeds a packet processing rate or bandwidth usage threshold that may be used to ensure relatively high priority data traffic or services in the network device/node 110.

The ingress arbiter 220 (also referred to as “IARB”) can include or implement an enqueuing/dequeuing (also referred to as “ENQ/DEQ”) ingress processor—which may be a single scheduler in the ingress arbiter in some operational scenarios—to perform intake and/or ingress arbitration operations on incoming packets (denoted as “Pkt In” in FIG. 3A) received with ingress ports (e.g., 210 of FIG. 2B, etc.). The ingress arbiter 220 or the ingress processor or scheduler therein can operate with one or more relatively deep (main) packet memory buffers (each of which may have a capacity exceeding 5+ Mbytes) to store or buffer packet data such as headers and payloads carried in the incoming packets.

In addition, under techniques as described herein, the ingress arbiter 220 or the ingress processor or scheduler therein can operate with one or more relatively shallow accelerated (e.g., smaller, faster, etc.) memory buffers to store or buffer relatively small packet data portions such as headers (or SOP information) carried in the incoming packets. An accelerated memory buffer or space used in the no congestion state may have a relatively small capacity such as a size configured to store headers or SOP portions of packets in the no-congestion state, for example with each header or SOP size of up to 128 bytes times a total number of ingress ports operating with the ingress arbiter.

At the time of dequeuing the buffered packets for further processing by downstream packet processing components in the same network device/nodes 110 such as one or more ingress packet processors 230 and one or more traffic managers 240, the ingress arbiter 220 can output the buffered packets to these downstream packet processing components in two packet data portions. By way of example but not limitation, the ingress arbiter 220 can output a first packet data portion in the form of a Start-of-packet (SOP) portion of an incoming or buffered packet to an ingress packet processor 230 for making specific forwarding decisions or selecting a specific forwarding path for the incoming packet.

In some operational scenarios, as illustrated in FIG. 3A, the ingress packet processor 230 receives the header or SOP information of the buffered packet from the ingress arbiter 220, makes the forwarding decisions for the buffered packet, generates packet metadata for the buffered packet, and so on. The packet metadata may specify the forwarding decisions or other packet control data—for the buffered packet—to be used by downstream packet processing components in further processing the buffered packet.

In addition, the ingress arbiter 220 can output a second packet data portion in the form of a payload portion of the incoming or buffered packet. The payload portion may have been buffered as a part of the incoming or buffered packet in a relatively deep packet memory buffer—to a traffic manager 240 (or an ingress arbitration block therein) until the forwarding decisions made by the ingress packet processor 230 are received by the traffic manager and/or until further traffic management operations in connection with a specific egress packet processor 250 and/or a specific egress port (e.g., 290 of FIG. 2B, etc.) used to forward the buffered packet (denoted as “Pkt Out” in FIG. 3A) are to be performed for the received incoming or buffered packet.

In some operational scenarios, as illustrated in FIG. 3A, a header merge operation 350 may be performed to combine or merge the header/SOP of the buffered packet outputted from the ingress packet processor 230 with the payload portion of the buffered packet outputted from the ingress arbiter 220. This header merging operation 350 may be performed based at least in part on the packet metadata for the buffered packet as generated by the ingress packet processor 230.

Under some approaches, an ingress arbiter may operate with a scheduler (or ENQ/DEQ ingress processor) that performs enqueuing (ENQ) and dequeuing (DEQ) operations on an SOP portion and other (e.g., payload, etc.) portions of an ingress packet stored in the same packet buffer. Enqueuing the ingress packet in the ingress arbiter involves writing the relatively small sized SOP portion with the payload portions in the packet buffer involves generating relatively complex linking data structures and writing data into a relatively large number of memory units. Conversely, dequeuing the ingress packet involves reading the relatively small sized SOP portion among the memory units storing both the SOP and payload portions in the packet buffer involves using memory reference/address indirection operations through the relatively complex linking data structures. In addition, SOP specific operations such as lookup operations may need to be performed with the SOP portion. As a result, enqueuing and dequeuing the SOP portion may dictate the overall delay or time latency in processing the ingress packet by the ingress arbiter.

In contrast, under techniques as described herein, in some operational scenarios, a separate processing pipeline or path based at least in part on a relatively small fast accelerated memory space is implemented or used by an ingress arbiter to enqueue and dequeue SOP portions of ingress packets. Example operational scenarios in which this separate processing pipeline or path is used may include, but are not necessarily limited to only, when the ingress arbiter is operating in a no congestion state, when an oversubscription (e.g., egress bandwidth, as measured with an oversubscription or congestion threshold, etc.) is not present for egress ports or other resources, or when lossless buffering (e.g., to guarantee relatively high priority network/data traffic, etc.) is not being performed by the ingress arbiter or the network node, etc.

In these operational scenarios, an SOP portion of an ingress packet can be accelerated by a scheduler using the accelerated memory space and an alternate ENQ/DEQ ingress processor to substantially (e.g., more than 50%, 90%, 80%, etc.) reduce time delays/latencies incurred in enqueuing and dequeuing operations performed on the SOP portion of the ingress packet in the ingress arbiter, thereby substantially reducing overall time delays/latencies incurred in enqueuing and dequeuing operations performed on the ingress packet in the ingress arbiter.

FIG. 3B illustrates example ingress arbitration operations performed by an ingress arbiter 220 of a network device/node 110 in a communication network as described herein. Some or all of the processing components described herein are implemented in application-specific integrated circuits (ASICs), field programmable gate arrays (FPGAs), or other integrated circuit(s). The network device/node 110 or the ingress arbiter 220 may include one or more memories storing instructions for implementing various components described herein, one or more hardware processors configured to execute the instructions stored in the one or more memories, and various data repositories in the one or more memories for storing data structures utilized and manipulated by the various components.

As illustrated in FIG. 3B, ingress or incoming packets (denoted as “Pkt In” in FIG. 3B) may be received by the ingress arbitrator 220 or an ingress (packet) classify and admit module 302 therein. The ingress packet classify operation performed by the module 302 may analyze and categorize incoming packets based at least in part on one or more criteria or attributes such as traffic type (e.g., voice, video, data, etc.), quality of service (QOS) based at least in part on priority levels or service levels, protocol type (e.g., TCP, UDP, etc.), source/destination such as source/destination IP address or port, etc. The classification or categorization of the ingress packets may be used by the ingress arbiter 220 to determine which processing or forwarding policies—specific and/or general to the ingress packets—are to be applied to these ingress packets.

The ingress packet admit operation may be performed by the module 302 to determine whether a given ingress packet is to be accepted for further processing by the network device/node 110, for example, based on one or more packet admission factors such as available packet processing resources (e.g., buffers, memory and/or queue spaces, etc.) for processing the packet. Additionally, optionally or alternatively, traffic policing, congestion control, access control, etc., may be performed by the module 302 to enforce predefined rate limits or traffic shaping policies, to reject, drop, delay or mark if there is congestion in the network or the network device/node 110, to comply with security or access control policies, to tag or forward the ingress packet to other packet processing components of the network device/node 110 if there is no violation in resource constraints or policies or if it is otherwise determined that the ingress packet is admissible, etc.

The ingress arbiter 220 can monitor rates at which the incoming or ingress packets are arriving. If the packet arrival rate exceeds processing capacity or link bandwidth (e.g., oversubscription, etc.) of the network device/node 110 or packet processing components therein, the ingress arbiter 220 may take or perform actions to prevent packet loss. For example, the ingress arbiter 220 can implement or perform flow control protocol operations (e.g., backpressure, pause frames, etc.) to prevent data loss due to congestion. When congestion is detected, the ingress arbiter 220 can signal upstream devices to slow down the rate of packet transmission to avoid overwhelming resources (e.g., buffers, queues, etc.) at the network device/node 110.

The ingress arbiter 220 can ensure packet data of some or all of the ingress packets to be buffered in a lossless manner as a part of ingress packet enqueuing operations even if the network device/node 110 or network data paths/links become congested. This lossless buffering allows the packets to be stored temporarily in a packet memory until there is enough capacity to process them or forward them without any loss of data.

By way of illustration but not limitation, as shown in FIG. 3B, in or upon enqueuing the incoming or ingress packets, the ingress arbiter 220 may operate with a fast buffer redirect module 304 and/or a buffering logic (or buffer manager) to write, store, maintain or buffer at least non-SOP portions such as payloads of the incoming or ingress packets in a packet buffer such as a packet memory device 308, until these packets are dequeued from the ingress arbiter to be sent or delivered to downstream packet processing components such as traffic manager(s).

Additionally, optionally, or alternatively, SOP portions or headers of the incoming or ingress packets may also be written, stored, maintained or buffered in the packet buffer, along with the non-SOP portions such as the payloads of the incoming or ingress packets. In some operational scenarios, writing, storing, maintaining or buffering the SOP portions or headers in the packet buffer temporarily may be performed regardless of whether or not the ingress arbiter detects that a congestion event occurs. In some other operational scenarios, writing, storing, maintaining or buffering the SOP portions or headers in the packet buffer temporarily may only be performed when the ingress arbiter detects that a congestion event occurs.

As used herein, a congestion event occurs when a congestion measure reaches or exceeds a (e.g., system configured, user configured, etc.) congestion measure threshold. In an example, when an oversubscription event or condition-corresponding to actual bandwidth usage exceeding a total available/configured bandwidth of the network device/node 110 or one or more packet processing resources (e.g., queues, buffers, packet rates, etc.) used by one or more packet processing components therein—is detected, the ingress arbiter may determine or detect that a congestion event or condition has occurred. In another example, when an ingress packet arrival rate across one or more ingress ports has been detected to reach or exceed a specific percentile of an available bandwidth, the ingress arbiter may determine or detect that a congestion/oversubscription event or condition has occurred.

Given there may be more time consuming operations—including but not limited to SOP lookup and analysis operations—to be performed in connection with the SOP portions or headers of the ingress or incoming packets, SOP or related processing operations may dictate or dominate overall time delays or latencies incurred in overall packet processing operations of the ingress or incoming packets in the ingress arbiter 220.

In contrast with other approaches that do not implement techniques as described herein, in the ingress arbiter 220 as described herein, SOP acceleration may be achieved by using an accelerated memory 306—of relatively small size and fast memory access (e.g., with relatively low time latency, etc.) as compared with the packet buffer 308—and an (alternate or additional or bifurcated) ENQ/DEQ pipeline or path based on the accelerated memory 306.

In some operational scenarios in which the ingress arbiter 220 determines, for example based at least on one or more congestion related measures/levels, that the accelerated memory 306 and the alternative ENQ/DEQ pipeline/path are to be invoked or used (e.g., one or more per port thresholds in memory or memory usage/utilization have not been reached, etc.), in or upon enqueuing the incoming or ingress packets, the ingress arbiter 220 may operate with the fast buffer redirect module 304 and the accelerated memory 306 to write, store, maintain or buffer the (uncongested) SOP portions or headers or SOP control data—which may be duplicates of the SOP portions or headers stored in the packet buffer 308—of the ingress or incoming packets in the smaller and faster accelerated memory 306 using the alternate ENQ/DEQ pipeline or path based on the accelerated memory 306.

In some other operational scenarios in which the ingress arbiter 220 determines, for example based at least on the one or more congestion related measures/levels (e.g., one or more per port thresholds in memory or memory usage/utilization have been reached, etc.), that the accelerated memory 306 and the alternative ENQ/DEQ pipeline/path are not to be invoked or used, in or upon enqueuing the incoming or ingress packets, the ingress arbiter 220 may operate with the fast buffer redirect module 304 and the accelerated memory 306 to write, store, maintain or buffer the (congested) SOP portions or headers or SOP control data, along with the payloads or other non-SOP portions, of the ingress or incoming packets (e.g., only, etc.) in the larger and slower packet buffer 308 using the (main or default) ENQ/DEQ pipeline or path based on the packet buffer 308.

As illustrated in FIG. 3B, the ingress arbiter 220 may include or operate with a scheduler 310 (or ingress processor) to perform some or all dequeuing operations with respect to the ingress or incoming packets. For example, the scheduler 310 may schedule and perform dequeuing the SOP portions or headers or SOP control data from one or both of the accelerated memory 306 and the packet buffer 308.

More specifically, in response to determining (e.g., based on one or more scheduling algorithms implemented in the ingress arbiter 220, etc.) that dequeuing an SOP portion or header of an ingress or incoming packet is scheduled to occur, the scheduler 310 may instruct/invoke a FIFO fetch logic to fetch the SOP portion or header from the accelerate memory 306 with relatively low delay or latency and enter the SOP portion or header into a first SOP FIFO maintained by an arbitration logic (denoted as “ARB”) in the ingress arbiter 220. Additionally, optionally or alternatively, the scheduler 310 may (e.g., concurrently, etc.) instruct/invoke the buffering logic (or buffer manager) to use the inter-packet and/or intra-packet linking data structures such as memory address linked lists, read the SOP portion or header from the packet buffer 308 based on the linking data structures with relatively large delay or latency, and enter the SOP portion or header into a second SOP FIFO maintained by the arbitration logic in the ingress arbiter 220. The SOP portions or headers or SOP control data from one or both of the accelerated memory 306 may be arbitrated by an arbitration logic (denoted as “ARB”) before (e.g., a single copy, etc.) being outputted to downstream packet processing logic engines in the network device/node 110 such as one or more ingress packet processors 230, one or more egress packet processors 250, etc.

In operational scenarios, in which the SOP portion or header of the ingress or incoming packet only exists or is only stored in one of the accelerated memory 306 and the packet buffer 308, the uncongested or congested SOP portion or header—of the ingress or incoming packet—from whichever available memory location in one of the accelerated memory 306 and the packet buffer 308 is fetched or read and sent to a downstream packet processing component such as an ingress processor 230, which may use the SOP portion or header from the ingress arbiter 220 to make forwarding decisions for the ingress or incoming packet.

In operational scenarios, in which the SOP portion or header of the ingress or incoming packet exists or is stored/copied in both of the accelerated memory 306 and the packet buffer 308, the (SOP output) arbitration logic of the ingress arbiter 220 may implement an arbitration mechanism or algorithm (e.g., first come first serve, select whichever is available earlier, etc.) to select one of the two copies of the SOP portions or headers—of the ingress or incoming packet—available in both the accelerated memory 306 and the packet buffer 308 and sent to the downstream packet processing component or ingress processor 230, which may use the SOP portion or header from the ingress arbiter 220 to make forwarding decisions for the ingress or incoming packet.

In addition, in response to determining (based on the scheduling algorithms implemented in the ingress arbiter 220) that dequeuing an SOP portion or header of an ingress or incoming packet is scheduled to occur, the scheduler 310 may (e.g., concurrently, etc.) instruct/invoke the buffering logic (or buffer manager) to use the same inter-packet and/or intra-packet linking data structures or memory address linked lists, read packet data—including but not necessarily limited to only at least other non-SOP (or non-header) portions—of the ingress or incoming packet from the packet buffer 308 based on the same linking data structures with relatively large delay or latency, and output the packet data of the ingress or incoming packet to downstream packet processing logic engines in the network device/node 110 such as a traffic manager 240.

The fast buffer redirect module 304 can be implemented or used as a support mechanism in the ingress arbiter 220 to control whether the accelerated memory 308 and the alternative ENQ/DEQ pipeline or path should be used.

In some operational scenarios, oversubscription or congestion does not occur. In these operational scenarios, there are benefits in accelerating ingress arbitration ENQ/DEQ operations, which will not overwhelm or overutilize capacities and resources of the downstream packet processing components. Storing the SOP portions or bytes of the ingress or incoming packets in the accelerated memory 306 of the alternative ENQ/DEQ pipeline/path allows the ingress arbiter 220 or the network device/node 110 to use the low latency alternative scheduling ENQ/DEQ pipeline/path and enable relatively fast memory access with relatively small latency inter-packet and/or intra-packet linking and maintain relatively low latency in its overall enqueuing and dequeuing operations of the ingress or incoming packets. This may be especially beneficial for latency sensitive traffic services when the network device/node 110 does not experience oversubscription or congestion.

On the other hand, the accelerated memory 308 and the low latency alternative ENQ/DEQ pipeline or path may be stopped or prevented from being used, in operational scenarios in which oversubscription or congestion occurs and/or there is no need or benefit to accelerate ingress arbitration ENQ/DEQ operations, as accelerated enqueuing in these operational scenarios could overwhelm or overutilize capacities and resources of the accelerated memory and/or the alternative ENQ/DEQ pipeline/path and/or could also overwhelm or overutilize capacities and resources of the downstream packet processing components. In some operational scenarios, when oversubscription or congestion occurs, one or more ingress and/or egress ports can be flow controlled by the ingress arbiter 220 and/or the traffic manager 240 to alleviate overutilization of resources.

The ingress arbiter 220 or the fast buffer redirect module 304 may determine or identify specific operational scenarios, in which the accelerated memory 308 and the low latency alternative ENQ/DEQ pipeline or path may be stopped or prevented from being used, based at least on comparing one or more congestion/oversubscription (or related) measures/levels with one or more (packet acceleration or congestion related) thresholds and criteria.

In an example, the fast buffer redirect module 304 or the ingress arbiter 220 may determine whether available (e.g., across ports, per-port, etc.) capacity or space in the accelerated memory 306—and/or the packet buffer 308—exceeds a specific system and/or user configured available capacity/space threshold. By way of illustration but not limitation, accelerated memory buffer usages, utilizations or fill levels due to storing SOP portions of ingress packets received from one or more ingress ports may be monitored, determined or computed. Some or all of these buffer usages, utilizations or fill levels may be used as congestion measures to be compared with system or user configured congestion thresholds. When any, some or all of the usages, utilizations or fill levels exceed any, some or all per port or across port memory usage, utilization or fill level thresholds configured for the ingress ports, the ingress arbiter 220 or the fast buffer redirect module 340 therein may determine that a congestion event or condition has occurred.

In another example, the fast buffer redirect module 304 or the ingress arbiter 220 may determine whether available (e.g., across ports, per-port, etc.) capacity or space in the FIFO maintained by the SOP output arbiter exceeds a specific available capacity/space threshold.

In yet another example, the fast buffer redirect module 304 or the ingress arbiter 220 may determine whether one or more ports such as egress ports to which ingress or incoming packets are to be forwarded out to next hops are in uncongested or congested state(s). A port may be in a congested state if buffer(s) or queue(s) used or shared by the port are not overutilized (e.g., not reaching or exceeding maximum utilization threshold(s), etc.).

In a further example, the fast buffer redirect module 304 or the ingress arbiter 220 may determine whether one or more ingress or egress ports are currently operating with congestion related states. By way of illustration but not limitation, the fast buffer redirect module 304 may determine whether any, some or all of the ingress ports—or packet processing resources such as queues or buffers used by the ingress ports—from which ingress or incoming packets are received from other network devices/nodes are operating with (e.g., priority-based, etc.) flow control states, or are being flow-controlled, for example, by the ingress arbiter 220. Similarly, the fast buffer redirect module 304 may determine whether any, some or all of the egress ports—or packet processing resources such as queues or buffers used by the egress ports—to which output packets corresponding to the received ingress or incoming packets are to be forwarded out to next hop network devices or nodes are operating with (e.g., priority-based, etc.) flow control states, or are being flow-controlled, for example by traffic manager(s) 240.

In some operational scenarios, packet ingress arbitration processing is unaccelerated if one or more (e.g., any, some or all, etc.) of these congestion/oversubscription event/state/condition determinations are positive. In these operational scenarios, the accelerated memory and the alternative ENQ/DEQ pipeline/path based thereon are unused or are prevented from being used.

The packet acceleration or congestion related thresholds and criteria can be used—by the network device/node 110 including but not necessarily limited to only the ingress arbiter 220—not only to determine whether the accelerated memory or alternative ENQ/DEQ pipeline/path should be used but also to initiate and perform operations to manage congestion or oversubscription events or conditions that are occurring in the ingress arbiter 220 or the network device/node 110.

In an example, in response to determining that egress packet memory such as egress packet buffer(s) or queue(s) used by egress ports are congested or overutilized, the network device/node 110 or the ingress arbiter 220 may initiate or perform priority flow control (PFC) operations for lossless buffer(s) and/or queue(s)—for example the packet memory 308—maintained in the network device/node 110 or the ingress arbiter 220 to ensure relatively high priority data services or ingress traffic flows least or not affected by the congestion or oversubscription events or conditions.

In another example, in response to determining that congestion/oversubscription events or conditions are occurring with one or more ingress and/or egress ports or resources such as buffer(s) and queue(s) used by the ports, the ingress arbiter 220 or the fast buffer redirect 304 can redirect or causes SOP or header data of (newly) received ingress or incoming packets to be stored in the packet (memory) buffer 308, thereby taking the standard (non-alternative) path for enqueuing and dequeuing operations.

As noted, in some operational scenarios, in which the accelerated memory 306 and the alternative ENQ/DEQ pipeline/path are used, SOP or header data of ingress or incoming packets can be stored in both the accelerated memory 306 and the packet buffer 308 when enqueuing the ingress or incoming packets in the ingress arbiter 220. Hence, two copies of the SOP or header data of the ingress or incoming packets can be retrieved from both the accelerated memory 306 and the packet buffer 308 when dequeuing the ingress or incoming packets from the ingress arbiter 220. The SOP output arbitration logic may be implemented at an ingress packet processor interface so that one (e.g., first come first serve, etc.) of the two copies of the SOP or header data may be outputted by the SOP output arbitration logic of the ingress arbiter 220 to downstream ingress packet process(s), for example to make forwarding (path) decisions.

In various operational scenarios, whether or not the accelerated memory 306 and the alternative ENQ/DEQ pipeline or path based on the accelerated memory 306 are used to fast process SOP data, the ingress arbiter 220 or the scheduler 310 and/or the SOP output arbitration logic therein can maintain a specific packet processing order (e.g., to prevent packet reordering problems, etc.) in one or more ingress traffic flows, ensure fairness between or among these ingress traffic flows, and minimize (e.g., intra-flow, etc.) jitter, for example based on one or more scheduling algorithms used to buffer or manage ingress traffic flows.

The use of the accelerated memory 306 and the alternate ENQ/DEQ pipeline or path in the ingress arbiter 220 in some operational scenarios can provide a number of benefits and advantages. For example, delay and time latency associated with the standard or non-alternative (SOP) ENQ/DEQ pipeline or path by way of the relatively large (e.g., five megabytes per port, etc.) packet memory 308 can be reduced by a substantial amount such as a speedup of 50% (e.g., 87 versus 47 clocks) in these operational scenarios in which the relatively (e.g., 256 kilobytes, 512 kilobytes, etc.) small accelerated memory 306 and the alternative (SOP) ENQ/DEQ pipeline or path based on the accelerated memory 306 are used. In addition, changes made to the ingress arbiter architecture may be minimized.

FIG. 1, FIG. 2A, FIG. 2B, FIG. 3A and FIG. 3B illustrate representative examples of many possible alternative arrangements of devices configured to provide the functionality described herein. Other arrangements may include fewer, additional, or different components, and the division of work between the components may vary depending on the arrangement. Moreover, in an embodiment, the techniques described herein may be utilized in a variety of computing contexts other than within a network 100 or a network device 200.

Furthermore, figures herein illustrate but a few of the various arrangements of memories that may be utilized to implement the described buffering techniques. Other arrangements may include fewer or additional elements in varying arrangements.

### 6.0. Example Embodiments

Described in this section are various example method flows for implementing various features of the systems and system components described herein. The example method flows are non-exhaustive. Alternative method flows and flows for implementing other features will be apparent from the disclosure.

The various elements of the process flows described below may be performed in a variety of systems, including in one or more computing or networking devices that utilize some or all of the load balancing or traffic distribution mechanisms described herein. In an embodiment, each of the processes described in connection with the functional blocks described below may be implemented using one or more integrated circuits, logic components, computer programs, other software elements, and/or digital logic in any of a general-purpose computer or a special-purpose computer, while performing data retrieval, transformation, and storage operations that involve interacting with and transforming the physical state of memory of the computer.

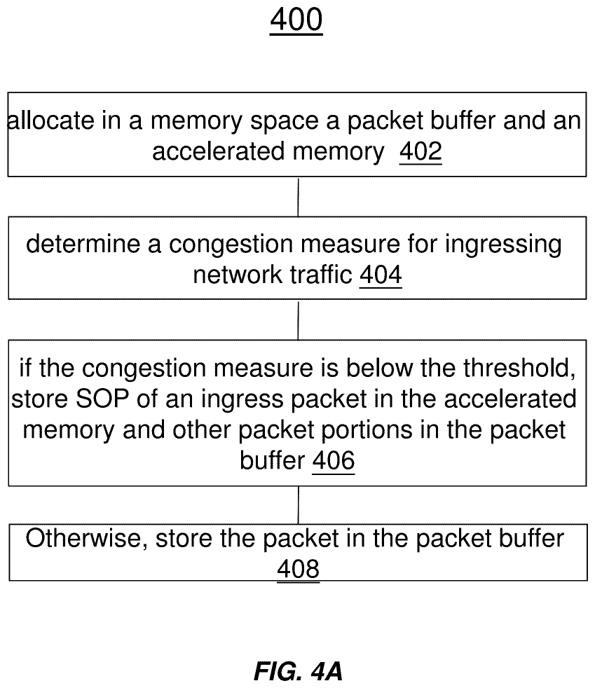

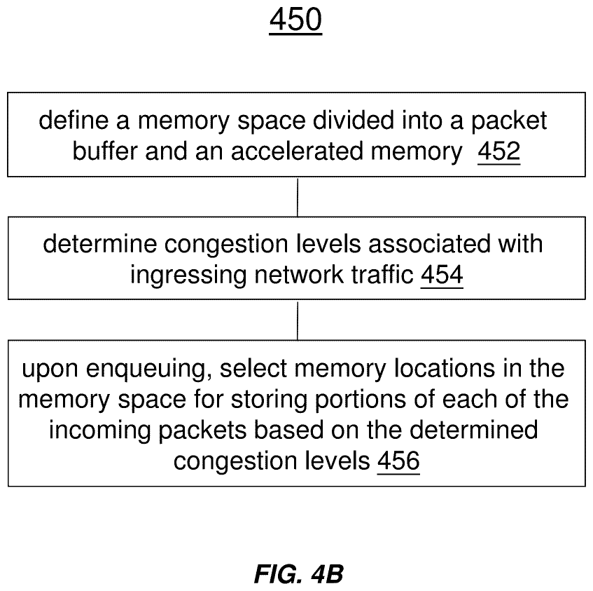

FIG. 4A illustrates an example process flow 400, according to an embodiment. The various elements of the flow described below may be performed by one or more network devices (or processing engines therein) implemented with one or more computing devices. In block 402, a network device as described herein or an ingress arbiter therein allocates in a memory space a packet buffer of a first size and having a first memory access latency and an accelerated memory of a second size that is smaller than the first size and having a second memory access latency that is smaller than the first memory access latency.

In block 404, the ingress arbiter determines a congestion measure for ingressing network traffic.

In block 406, in response to determining that the congestion measure is below a congestion threshold, the ingress arbiter enqueues an ingress packet by: storing a start-of-packet (SOP) portion of the ingress packet in the accelerated memory space; storing one or more non-SOP portions of the ingress packet in the packet buffer; etc.

In block 408, in response to determining that the congestion measure is not below the congestion threshold, the ingress arbiter enqueues the ingress packet by storing all portions of the ingress packet in the packet buffer.

In an embodiment, upon dequeuing the packet, the ingress arbiter retrieves the SOP portion of the ingress packet from one of the accelerated memory and packet buffer and sends the retrieved SOP portion of the ingress packet to an ingress packet processor.

In an embodiment, the congestion measure is determined based at least in part on one or more of: i) memory usages due to storing SOP portions of ingress packets received from one or more ingress ports, ii) one or more flow control states of one or more ingress ports, iii) one or more flow control states of one or more egress ports of the network device, iv) one or more flow control states of packet processing resources used by one or more ingress ports, v) one or more flow control states of packet processing resources used by one or more egress ports of the network device, vi) an overall bandwidth usage exceeding an oversubscription bandwidth usage threshold at the network device, etc.

In an embodiment, the size of the accelerated memory is determined at least based in part on one or more of: a total number of ingress ports, a total number of egress ports, and a size of a SOP portion of an ingress packet.

In an embodiment, the ingress arbiter merges the SOP portion of the ingress packet with the other portions of the ingress packet retrieved from the packet buffer into an overall packet to be processed by a traffic manager along with packet metadata generated for the ingress packet by an ingress packet processor.

In an embodiment, the SOP portion of the ingress packet is directly accessible in the accelerated memory without indirect reference; the other portions of the ingress packet in the packet buffer is indirectly accessible through indirect reference based at least in part on one or more packet linking data structures.

In an embodiment, in response to determining that a current memory usage of the packet buffer exceeds a configured packet buffer usage threshold, the ingress arbiter applies priority-based flow controls to lossless queues used to support lossless data services.

In an embodiment, the packet buffer is located in a same shared physical memory device in which the accelerated memory is located.

In an embodiment, the packet buffer is located in a first physical memory device separate from a second physical memory device in which the accelerated memory is located.

FIG. 4B illustrates an example process flow 450, according to an embodiment. The various elements of the flow described below may be performed by one or more network devices (or processing engines therein) implemented with one or more computing devices. In block 452, a network device as described herein or an ingress arbiter therein defines a memory space that is divided into a packet buffer and an accelerated memory.

In block 454, the ingress arbiter determines one or more congestion levels associated with ingress network traffic.

In block 456, upon enqueuing incoming packets, the ingress arbiter selects one or more memory locations in the memory space for storing portions of each of the incoming packets based on at least one of the determined congestion levels.

In an embodiment, the one or more selected memory locations includes a memory location in the accelerated memory for storing a start-of-packet (SOP) portion of an incoming packet in response to determining that the at least one of the determined congestion levels is below a congestion level threshold.

In an embodiment, the one or more selected memory locations includes a memory location in the packet buffer for storing a start-of-packet (SOP) portion of an incoming packet in response to determining that the at least one of the determined congestion levels reaches or exceeds a congestion level threshold.

In an embodiment, a computing device such as a switch, a router, a line card in a chassis, a network device, etc., is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Note that, although separate embodiments are discussed herein, any combination of embodiments and/or partial embodiments discussed herein may be combined to form further embodiments.

### 7.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the inventive subject matter have been described with reference to numerous specific details that may vary from implementation to implementation. Thus, the sole and exclusive indicator of what is the inventive subject matter, and is intended by the applicants to be the inventive subject matter, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for processing network packet traffic, the method comprising:
allocating in a memory space a packet buffer of a first size and having a first memory access latency and an accelerated memory of a second size that is smaller than the first size and having a second memory access latency that is smaller than the first memory access latency;
determining a congestion measure for ingressing network traffic;
in response to determining that the congestion measure is below a congestion threshold, enqueuing an ingress packet by:
storing a start-of-packet (SOP) portion of the ingress packet in the accelerated memory;
storing one or more non-SOP portions of the ingress packet in the packet buffer; and
in response to determining that the congestion measure is not below the congestion threshold, enqueuing the ingress packet by storing all portions of the ingress packet in the packet buffer.

2. The method of claim 1, further comprising: upon dequeuing the packet, retrieving the SOP portion of the ingress packet from one of the accelerated memory and packet buffer and sending the retrieved SOP portion of the ingress packet to an ingress packet processor.

3. The method of claim 1, wherein the congestion measure is determined based at least in part on one or more of: i) memory usages due to storing SOP portions of ingress packets received from one or more ingress ports, ii) one or more flow control states of one or more ingress ports, iii) one or more flow control states of one or more egress ports of the network device, iv) one or more flow control states of packet processing resources used by one or more ingress ports, v) one or more flow control states of packet processing resources used by one or more egress ports of the network device, or vi) an overall bandwidth usage exceeding an oversubscription bandwidth usage threshold at the network device.

4. The method of claim 1, wherein the size of the accelerated memory is determined at least based in part on one or more of: a total number of ingress ports, a total number of egress ports, and a size of a SOP portion of an ingress packet.

5. The method of claim 1, further comprising: merging the SOP portion of the ingress packet with the other portions of the ingress packet retrieved from the packet buffer into an overall packet to be processed by a traffic manager along with packet metadata generated for the ingress packet by an ingress packet processor.

6. The method of claim 1, wherein the SOP portion of the ingress packet is directly accessible in the accelerated memory without indirect reference, wherein the other portions of the ingress packet in the packet buffer is indirectly accessible through indirect reference based at least in part on one or more packet linking data structures.

7. The method of claim 1, further comprising: in response to determining that a current memory usage of the packet buffer exceeds a configured packet buffer usage threshold, applying priority-based flow controls to lossless queues used to support lossless data services.

8. The method of claim 1, wherein the packet buffer is located in a same shared physical memory device in which the accelerated memory is located.

9. The method of claim 1, wherein the packet buffer is located in a first physical memory device separate from a second physical memory device in which the accelerated memory is located.

10. A method for processing network packet traffic, the method comprising:
defining a memory space that is divided into a packet buffer and an accelerated memory;
determining one or more congestion levels associated with ingress network traffic; and
upon enqueuing incoming packets, selecting one or more memory locations in the memory space for storing portions of each of the incoming packets based on at least one of the determined congestion levels.

11. The method of claim 10, wherein the one or more selected memory locations includes a memory location in the accelerated memory for storing a start-of-packet (SOP) portion of an incoming packet in response to determining that the at least one of the determined congestion levels is below a congestion level threshold.

12. The method of claim 10, wherein the one or more selected memory locations includes a memory location in the packet buffer for storing a start-of-packet (SOP) portion of an incoming packet in response to determining that the at least one of the determined congestion levels reaches or exceeds a congestion level threshold.

13. A network switching system, comprising:
an ingress arbiter configured to allocate in a memory space a packet buffer of a first size and having a first memory access latency and an accelerated memory of a second size that is smaller than the first size and having a second memory access latency that is smaller than the first memory access latency;
a packet memory buffer manager configured to write and read from the packet buffer;
wherein, in response to determining that the congestion measure is below a congestion threshold, the ingress arbiter is configured to enqueue an ingress packet by:
storing a start-of-packet (SOP) portion of the ingress packet in the accelerated memory;
storing one or more non-SOP portions of the ingress packet in the packet buffer; and
wherein, in response to determining that the congestion measure is not below the congestion threshold, the ingress arbiter is configured to enqueue the ingress packet by storing all portions of the ingress packet in the packet buffer.

14. The system of claim 13, further comprising: a scheduler that is configured to, upon dequeuing the packet, retrieve the SOP portion of the ingress packet from one of the accelerated memory and packet buffer and send the retrieved SOP portion of the ingress packet to an ingress packet processor.

15. The system of claim 13, wherein the congestion measure is determined based at least in part on one or more of: i) memory usages due to storing SOP portions of ingress packets received from one or more ingress ports, ii) one or more flow control states of one or more ingress ports, iii) one or more flow control states of one or more egress ports of the network device, iv) one or more flow control states of packet processing resources used by one or more ingress ports, v) one or more flow control states of packet processing resources used by one or more egress ports of the network device, or vi) an overall bandwidth usage exceeding an oversubscription bandwidth usage threshold at the network device.

16. The system of claim 13, wherein the size of the accelerated memory is determined at least based in part on one or more of: a total number of ingress ports, a total number of egress ports, and a size of a SOP portion of an ingress packet.

17. The system of claim 13, further comprising: a header merging logic engine that is configured to merge the SOP portion of the ingress packet with the other portions of the ingress packet retrieved from the packet buffer into an overall packet to be processed by a traffic manager along with packet metadata generated for the ingress packet by an ingress packet processor.

18. The system of claim 13, wherein the SOP portion of the ingress packet is directly accessible in the accelerated memory without indirect reference, wherein the other portions of the ingress packet in the packet buffer is indirectly accessible through indirect reference based at least in part on one or more packet linking data structures.

19. The system of claim 13, wherein the ingress arbiter is configured to, in response to determining that a current memory usage of the packet buffer exceeds a configured packet buffer usage threshold, apply priority-based flow controls to lossless queues used to support lossless data services.

20. The system of claim 13, wherein the packet buffer is located in a same shared physical memory device in which the accelerated memory is located.

21. The system of claim 13, wherein the packet buffer is located in a first physical memory device separate from a second physical memory device in which the accelerated memory is located.

22. A network switching system, comprising:
an ingress arbiter that is configured to define a memory space that is divided into a packet buffer and an accelerated memory;
a packet memory buffer manager configured to write and read from the packet buffer;
wherein the ingress arbiter is configured to determine one or more congestion levels associated with ingress network traffic; and, upon enqueuing incoming packets, select one or more memory locations in the memory space for storing portions of each of the incoming packets based on at least one of the determined congestion levels.

23. The system of claim 22, wherein the one or more selected memory locations includes a memory location in the accelerated memory for storing a start-of-packet (SOP) portion of an incoming packet in response to determining that the at least one of the determined congestion levels is below a congestion level threshold.

24. The system of claim 22, wherein the one or more selected memory locations includes a memory location in the packet buffer for storing a start-of-packet (SOP) portion of an incoming packet in response to determining that the at least one of the determined congestion levels reaches or exceeds a congestion level threshold.
